(19) United States
(12) Patent Application Publication
(10) Pub. No.: US 2008/0155240 A1
(43) Pub. Date: Jun. 26, 2008

(54) INCREASING PERFORMANCE OF THE CREATION OF UPGRADE CONFIGURATIONS BASED ON HEURISTICS

(76) Inventors: Derek P. Bagwell, Rochester, MN (US); Cheranellore Vasudevan, Austin, TX (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/538,674

(22) Filed: Oct. 4, 2006

(51) Int. Cl. G06F 15/177

(52) U.S. Cl. 713/1

(57) ABSTRACT

In an embodiment, a current configuration specifies original parts in an electronic device, and solution configurations are created that include candidate parts that meet a requirement that specifies an upgrade to the current configuration. The solution configurations are created by adding a specification of candidate parts to a solution configuration and excluding the candidate parts from other solution configurations if the running total cost of the solution configuration plus the cost of a candidate part is less than an upper cost threshold. Candidate parts are selected from sources using a heuristic. One of the sources is the current configuration of the electronic device. In various embodiments, the requirement may be a storage amount or a performance level. In this way, in an embodiment, the performance of creating an upgrade configuration may be improved.

### FIELD

An embodiment of the invention generally relates to computer systems and more specifically relates to creating an upgrade configuration for parts in a computer system based on heuristics.

### BACKGROUND

Computer systems include a combination of interconnected parts, such as racks or cabinets, circuit boards, power supplies, processors, memory, storage devices, and cables. Computer system technology changes rapidly, so users of computer systems frequently desire to change, modify, or upgrade their computer systems, in order to increase performance or add new functions. Although users frequently have a goal in mind for their upgrade (e.g., a goal of increasing performance), they often do not know the specific upgraded configuration of parts that will accomplish that goal.

In fact, determining the optimal upgraded configuration that accomplishes the user's goal and utilizes some parts of the existing computer system and some new parts is a difficult problem. Difficulties occur because many parts are available, some parts have inter-dependency or compatibility problems, parts may be obtained from a variety of sources (e.g., current inventory, the manufacturer, or the existing system), and these sources have a variety of prices. Because of these difficulties, the process of configuring an upgrade order for a complex computer system is often very time consuming (5-10 days if done manually by experienced system engineers) or run-time performance intensive (tens of minutes to a few hours with current automated configuration tools). These problems are exacerbated if the user attempts to optimize the cost of the upgrade or the space used by the parts of the computer system or if the user wishes to generate multiple alternative configurations optimized for a variety of input considerations.

Thus, what is needed is a better way to create upgrade configurations. Although the aforementioned problems have been described in the context of computer systems, they may occur in the context of any device that is composed of parts.

### SUMMARY

A method, apparatus, system, and computer-readable storage medium are provided. In an embodiment, a current configuration specifies original parts in an electronic device, and solution configurations are created that include candidate parts that meet a requirement. The requirement specifies an upgrade to the current configuration, such as a storage amount or performance level. The solution configurations are created by adding a specification of a candidate part to a solution configuration and excluding the candidate part from other solution configurations if the running total cost of the solution configuration plus the cost of the candidate part is less than an upper cost threshold. The solution configuration with a final total cost that is less than a lower cost threshold is selected. Candidate parts are selected from sources using a heuristic. The sources with the lowest cost are used. One of the sources is the current configuration of the electronic device. In this way, in an embodiment, the performance of creating an upgrade configuration may be improved.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example data structure for a current configuration, according to an embodiment of the invention.

FIG. 3 depicts a block diagram of example data structure for solution configurations, according to an embodiment of the invention.

FIG. 4 depicts a block diagram of an example data structure for sources, according to an embodiment of the invention.

FIG. 5 depicts a block diagram of an example data structure for requirements, according to an embodiment of the invention.

FIG. 6 depicts a block diagram of an example data structure for heuristics, according to an embodiment of the invention.

FIG. 7 depicts a block diagram of an example data structure for thresholds, according to an embodiment of the invention.

FIG. 8 depicts a block diagram of an example data structure for excluded parts, according to an embodiment of the invention.

FIG. 9A depicts a flowchart of example processing for a configuration engine, according to an embodiment of the invention.

FIG. 9B depicts a flowchart of further example processing for a configuration engine, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment of the invention, a configuration engine receives a current configuration of an electronic device and a requirement. The current configuration specifies original parts in an electronic device, and the requirement specifies an upgrade to the current configuration. The configuration engine creates solution configurations that include candidate parts that meet the requirement. The configuration engine selects the candidate parts from sources and uses the source with the lowest cost for the candidate part. One of the sources is the current configuration of the electronic device. The configuration engine selects those candidate parts that meet a heuristic. The heuristic specifies a selection criteria, such as the original parts from the electronic device that are required in the solution configuration, parts or combinations of parts that are prohibited from being added to the solution configurations, or minimum or maximum quantities of parts. The heuristic may further specify a rule that, in an embodiment, specifies that a quantity of a part in the solution configuration may not exceed the quantity of the part in the best solution configuration created thus far. In another embodiment, the rule may specify that a part in the solution configuration must be identical to a part in the best solution configuration created thus far. The best solution configuration created thus far is the solution configuration with the lowest total final total cost thus far. The configuration engine adds a specification of a candidate part to a solution configuration and excludes that candidate part from other solution configurations if the running total cost of the solution configuration plus the cost of that candidate part is less than an upper cost threshold. The configuration engine then uses a lower cost threshold to select the best solution configuration.

The configuration engine prevents the needless creation of solution configurations that are unlikely to meet the lower cost threshold and reduces the number of combinations of parts that must be considered by using the upper cost threshold to decide whether to add candidate parts to the solution configuration, by applying the heuristics to restrict selection of some types of parts, and by halting evaluation of remaining candidate solutions by checking the total final cost of a created solution configuration against the lower threshold.

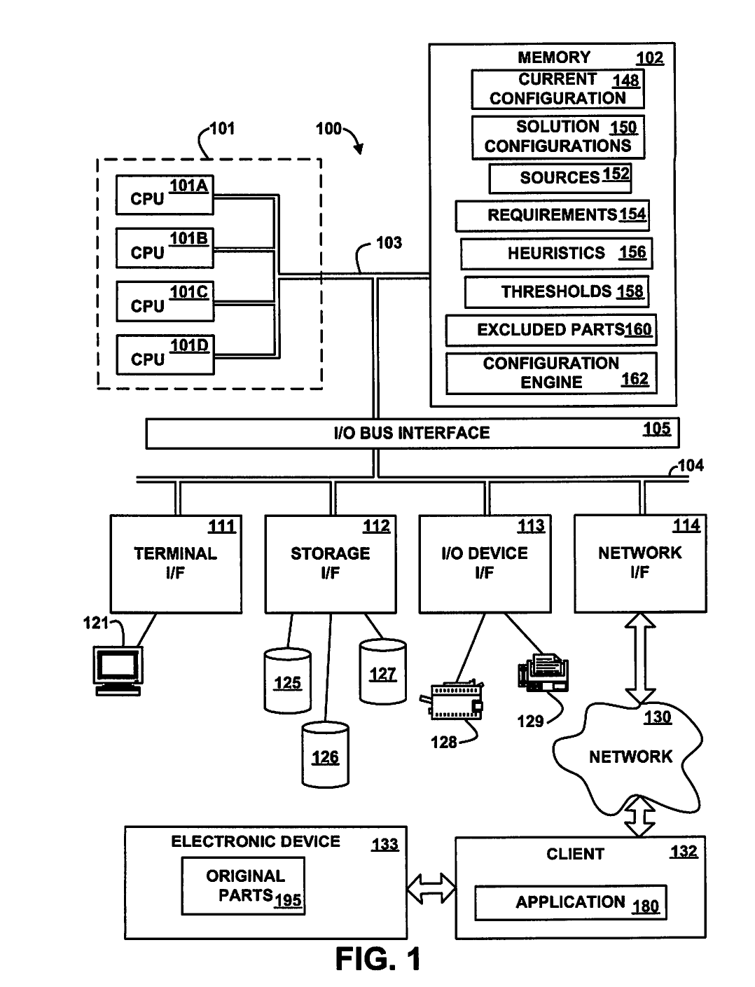

Referring to the Drawings, wherein like numbers denote like parts throughout the several views, FIG. 1 depicts a high-level block diagram representation of a server computer system 100 connected to a client computer system 132 via a network 130, according to an embodiment of the present invention. The terms “client” and “server” are used herein for convenience only, and in various embodiments a computer that operates as a client in one environment may operate as a server in another environment, and vice versa. The client computer system 132 is further connected to an electronic device 133. In an embodiment, the hardware components of the computer systems 100 and 132 and the electronic device 133 may be implemented by an eServer iSeries computer system available from International Business Machines Corporation of Armonk, N.Y. However, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/O (Input/Output) device interface 113, and communications/network interfaces 114, all of which are coupled for inter-component communication via a memory bus 103, an I/O bus 104, and an I/O bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes a current configuration 148, solution configurations 150, sources 152, requirements 154, heuristics 156, thresholds 158, excluded parts 160, and a configuration engine 162. Although the current configuration 148, the solution configurations 150, the sources 152, the requirements 154, the heuristics 156, the thresholds 158, the excluded parts 160, and the configuration engine 162 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the current configuration 148, the solution configurations, the sources 152, the requirements 154, the heuristics 156, the thresholds 158, the excluded parts 160, and the configuration engine 162 are illustrated as being contained within the main memory 102, these elements are not necessarily all completely contained in the same storage device at the same time. Further, although the current configuration 148, the solution configurations 150, the sources 152, the requirements 154, the heuristics 156, the thresholds 158, the excluded parts 160, and the configuration engine 162 are illustrated as being separate entities, in other embodiments some of them, portions of some of them, or all of them may be packaged together.

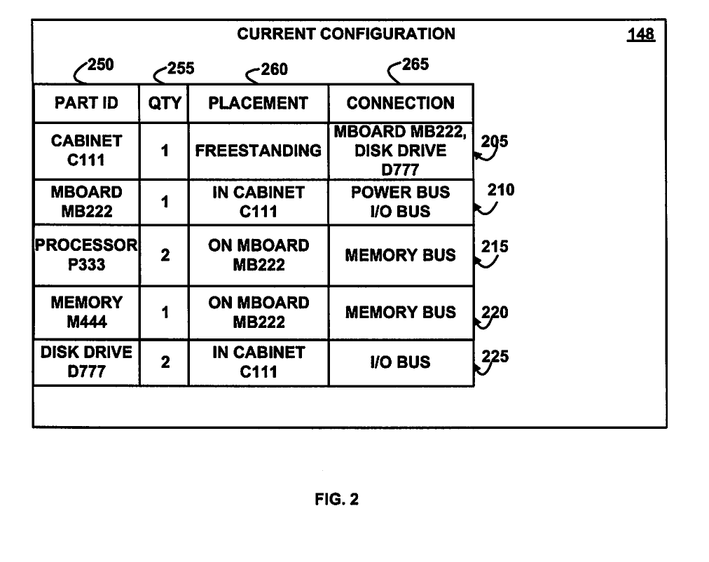

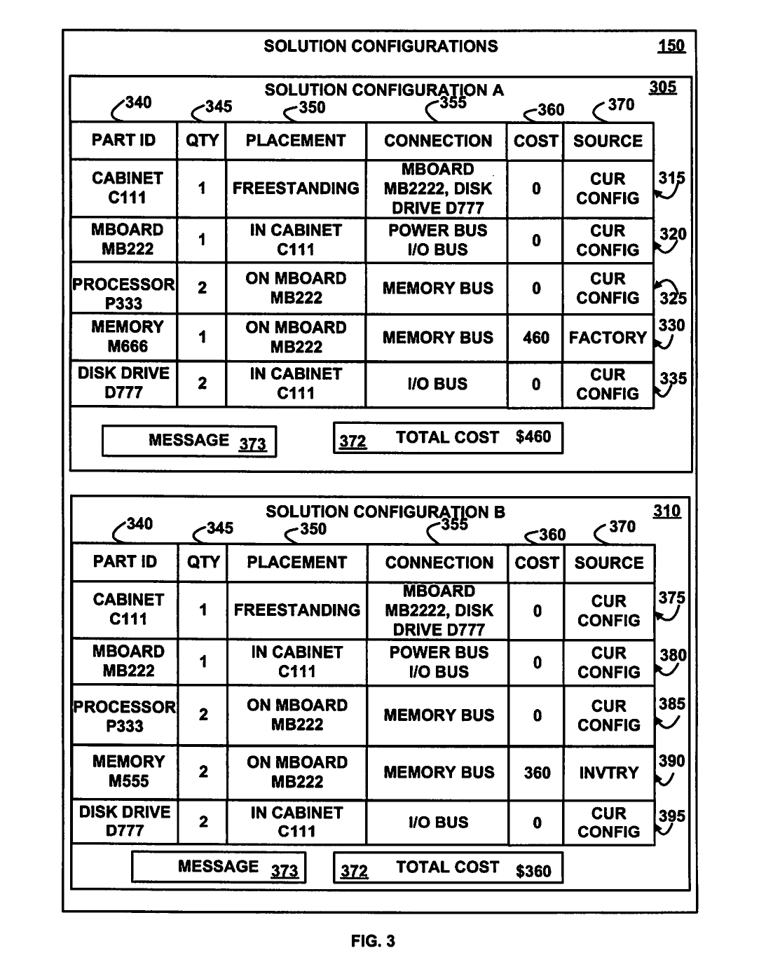

The current configuration 148 specifies or describes the current configuration of the original parts of the electronic device 133 prior to being upgraded. The current configuration 148 is further described below with reference to FIG. 2. The solution configurations 150 specify or describe alternative configurations of parts (some original and some different) that may be used to upgrade or change the electronic device 133. The configuration engine 162 creates the solution configurations 150 based on the current configuration 148, the sources 152, the requirements 154, the heuristics 156, and the thresholds 158. The solution configurations 150 are further described below with reference to FIG. 3.

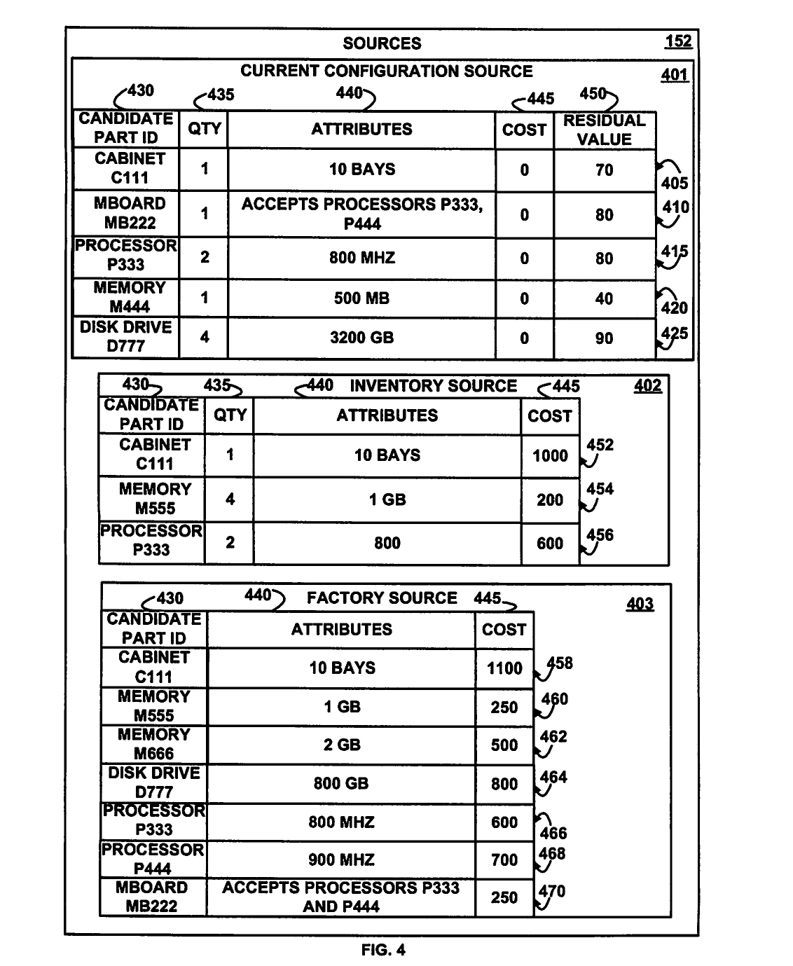

The sources 152 specify or describe the providers of parts that the configuration engine 162 may add to the solution configurations 150. Examples of sources include an inventory of new, used, refurbished, or reconditioned parts, the manufacturers, distributors, wholesalers, or retailers of parts, or the parts currently installed in the electronic device 133, as specified by the current configuration 148. The sources 152 may specify the parts that are available from the providers and the costs or prices of obtaining the parts from the providers. A particular part may be available from one or more sources 152, and the cost of the part may be the same or different, depending on the source. The sources 152 are further described below with reference to FIG. 4.

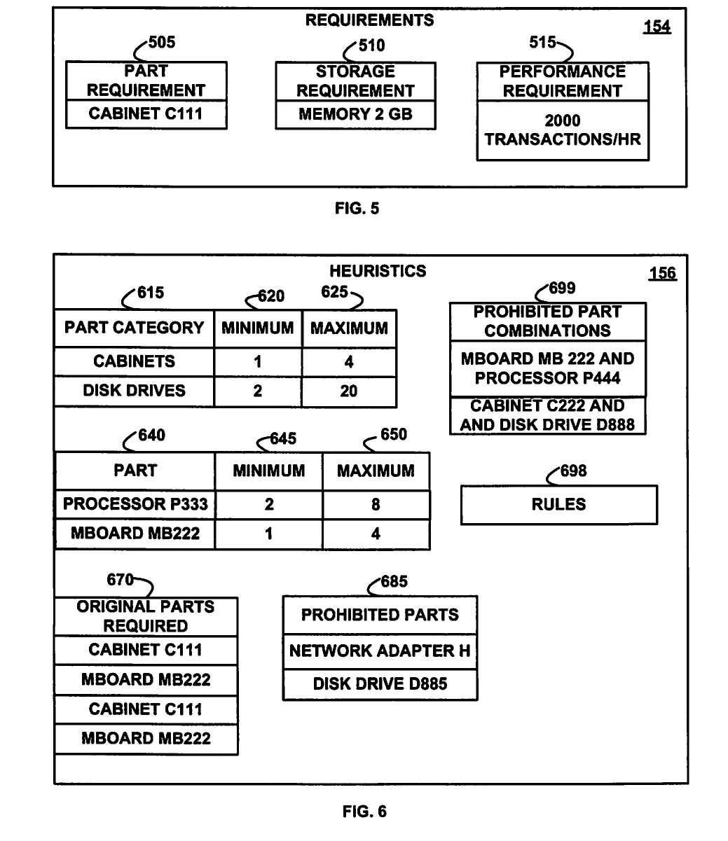

The requirements 154 specify a goal that the solution configurations 150 are to achieve. The configuration engine 162 creates the solution configurations 150 to meet the requirements 154. The requirements 154 may be expressed in terms of desired increased performance, storage capacity, or new or updated function. The requirements 154 are further described below with reference to FIG. 5.

The heuristics 156 specify a selection criteria for candidate parts that may be added to the solution configurations 150. The configuration engine 162 uses the heuristics 156 to reduce the combinatorial explosion of choices for parts to add to the solution configurations 150. Examples of a selection criteria include a specification of the original parts 195 from the electronic device 133 that are required in the solution configurations 150, a specification of parts that are prohibited in the solution configurations 150, a specification of combinations of parts that are prohibited in the solution configurations 150, a specification of a minimum quantity of parts that are required in the solution configurations 150, and a specification of a maximum quantity of parts that are allowed in the solution configurations 150. The heuristics 156 are further described below with reference to FIG. 6.

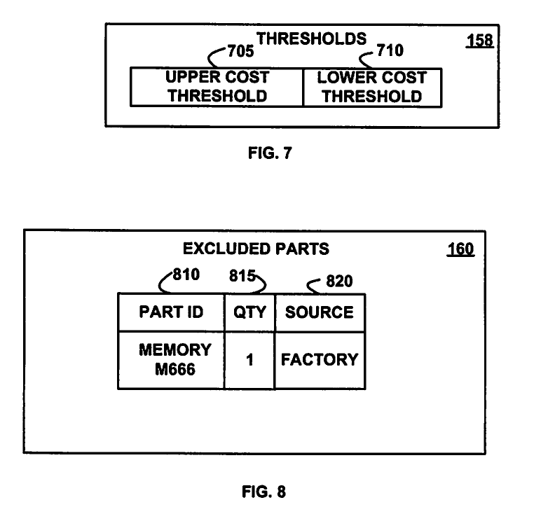

The thresholds 158 specify various cost thresholds that the configuration engine 162 uses to reduce the combinatorial explosion of choices for parts to add to the solution configurations 150 and to select a best solution configuration from among alternative solution configurations 150. The thresholds 158 are further described below with reference to FIG. 7.

The excluded parts 160 describe parts that the configuration engine 162 has analyzed for possible inclusion in a solution configuration 150 and has elected to exclude from further consideration for subsequent solution configurations. The excluded parts 160 are further described below with reference to FIG. 8.

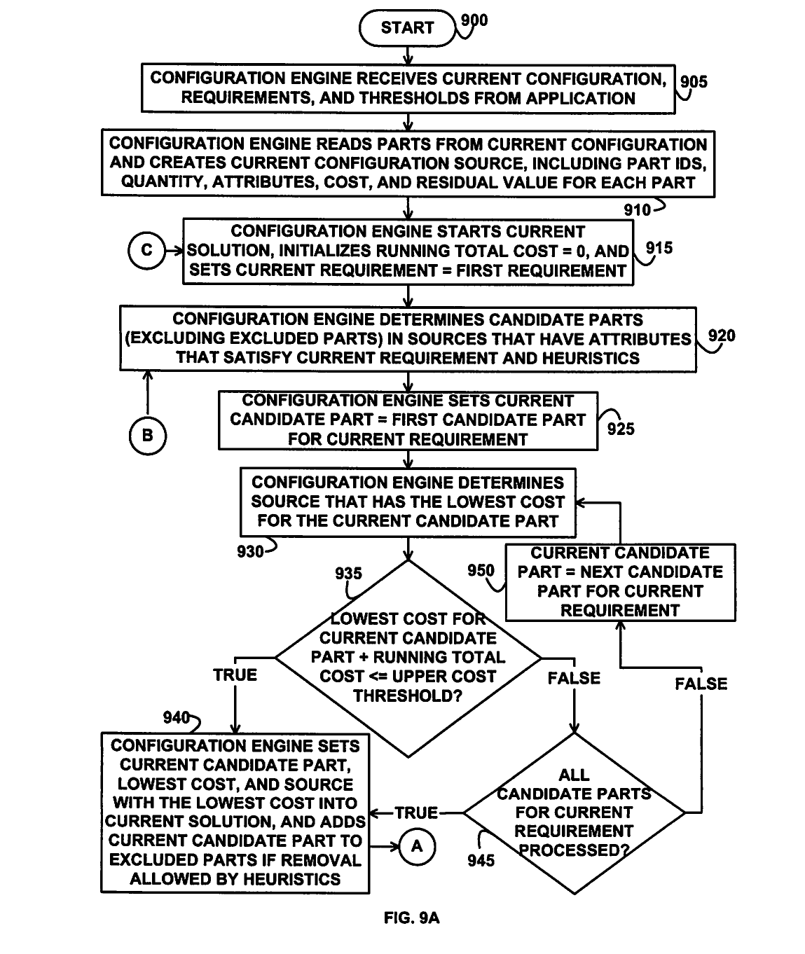

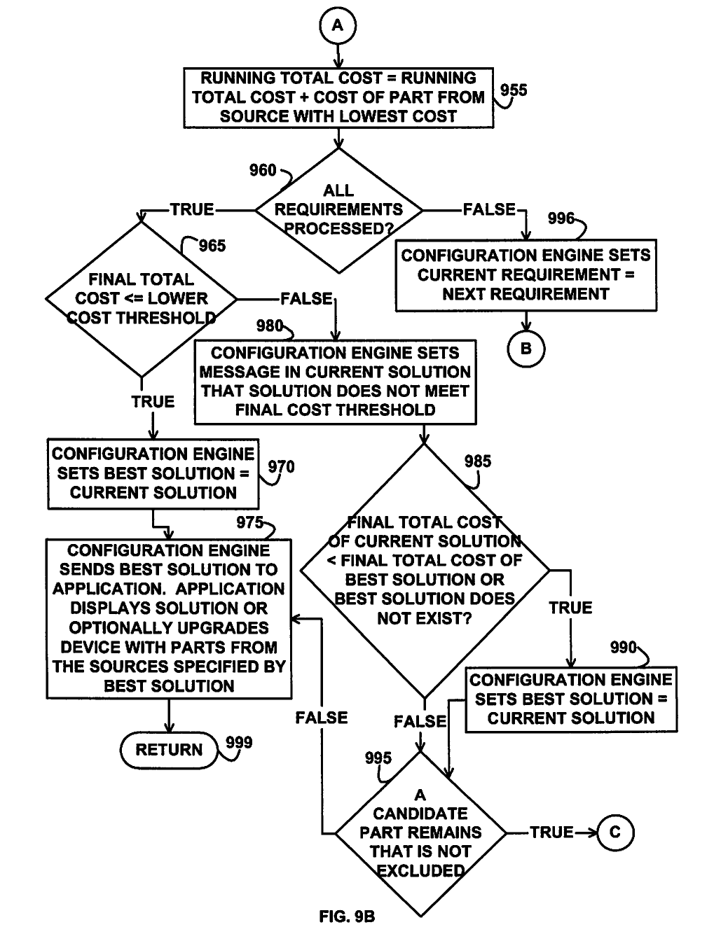

In an embodiment, the configuration engine 162 includes instructions capable of executing on the processor 101 or statements capable of being interpreted by instructions executing on the processor 101 to perform the functions as further described below with reference to FIGS. 9A and 9B. In another embodiment, the configuration engine 162 may be implemented in microcode. In another embodiment, the configuration engine 162 may be implemented in hardware via logic gates and/or other appropriate hardware techniques.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121. The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types. Two such devices, the printer 128 and the fax machine 129, are shown in the exemplary embodiment of FIG. 1, but in other embodiment many other such devices may exist, which may be of differing types. The network interface 114 provides one or more communications paths from the computer system 100 to other digital devices and computer systems; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In an embodiment, the computer system 100 may be a multi-user “mainframe” computer system, but embodiments of the invention are not limited to a particular size or type of computer system. The computer system 100 may alternatively be a single-user system, typically containing only a single user display and keyboard input, or might be a server or similar device which has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3x specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client 132 may include some or all of the hardware components previously described above as being included in the computer system 100. The client 132 includes an application 180, which may be encoded in memory with a description similar to the main memory 102. The application 180 sends requests to the configuration engine 162 at the computer system 100. The requests direct the configuration engine 162 to create the solution configurations 150, and the configuration engine 162 sends one or more of the solution configurations 150 to the application 180, which the application 180 may display via a display device similar to the display 121 or present via a speaker, printer, or other output device. The requests may include some or all of the current configuration 148, the requirements 154, the heuristics 156, and the thresholds 158. In an embodiment, the application 180 may be implemented via a browser, but in other embodiments the application 180 may be an operating system, a user application, a third-party application, or any appropriate program encoded with executable instructions or interpretable statements for execution on a processor similar to the processor 101. In another embodiment, the application 180 may implemented in hardware. In another embodiment, the application 180 may be implemented within the computer system 100, e.g., encoded in the memory 102 and executing on the processor 101.

The electronic device 133 is a computer system or other device that includes original parts 195. A user desires to upgrade, change, modify, or improve the electronic device 133 by replacing, changing one or more of the original parts 195 or adding new parts to the original parts 195. The original parts 195 may include some or all of the hardware components previously described above as being included in the computer system 100. In other embodiments, the original parts 195 may include any part or component capable of being connected to form an electronic device 133, such as cards, boards, chips, wires, transistors, resistors, invertors, capacitors, gates, flip-flops, counters, power supplies, fans, heat sinks, cables, adapters, cabinets, racks, processors, memory, storage devices, routers, modems, keyboards, displays, printers, fax machines, scanners, antennas, or any other appropriate part or collection of parts.

In an embodiment, the electronic device 133 is connected to the client 132, and the electronic device 133 sends its current configuration 148 to the application 180, which sends the current configuration 148 to the configuration engine 162. In another embodiment, the application 180 is implemented in the electronic device 133, and the client 132 is not necessary. In another embodiment, the electronic device 133 need not be connected to the client 132, and the current configuration 148 may be entered via a user input device, such as keyboard or microphone.

It should be understood that FIG. 1 is intended to depict the representative major components of the computer system 100, the network 130, the client computer system 132, and the electronic device 133 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., referred to hereinafter as “computer programs,” or simply “programs.” The computer programs typically comprise one or more instructions that are resident at various times in various memory and storage devices in the server computer system 100 and/or the client computer system 132, and that, when read and executed by one or more processors in the server computer system 100 and/or the client computer system 132, cause the server computer system 100 and/or the client computer system 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server computer system 100 and/or the client computer system 132 via a variety of tangible signal-bearing media that may be operatively or communicatively connected (directly or indirectly) to the processor or processors, such as the processor 101. The signal-bearing media may include, but are not limited to:

(1) information permanently stored on a computer-readable non-rewriteable storage medium, e.g., a read-only memory device attached to or within a computer system, such as a CD-ROM readable by a CD-ROM drive;

(2) alterable information stored on a computer-readable rewriteable storage medium, e.g., a hard disk drive (e.g., DASD 125, 126, or 127), the main memory 102, CD-RW, or diskette; or

(3) information conveyed to the computer system 100 and/or the client computer system 132 by a communications medium, such as through a computer or a telephone network, e.g., the network 130.

Such tangible computer-readable signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

FIG. 2 depicts a block diagram of an example data structure for a current configuration 148, according to an embodiment of the invention. The current configuration 148 includes records 205, 210, 215, 220, and 225, each of which includes a part identification field 250, a quantity field 255, a placement field 260, and a connection field 265. Each record identifies original part(s) 195 in the electronic device 133. The part identification field 250 identifies an original part 195. In various embodiments, the part identification field 250 may include some or all of include of the model, type, manufacturer, brand, class, category, or serial number of the original part. The quantity field 255 specifies the quantity, amount, or number of the original parts 195 specified by the part identification field 250. The placement field 260 specifies the location, site, or position of the original part identified by the part identification field in the electronic device 133. The connection field 265 identifies other original parts in the electronic device 133 to which the original part specified by the part identification field is connected.

FIG. 3 depicts a block diagram of example data structure for the solution configurations 150 that the configuration engine created, according to an embodiment of the invention. The solution configuration 150 includes alternative solution configurations 305 and 310, each of which specifies alternative configurations of parts (some original and some different) that may be used to upgrade or change the electronic device 133, in order to meet the requirements 154.

The solution configuration 305 includes records 315, 320, 325, 330, and 335. The solution configuration 310 includes records 375, 380, 385, 390, and 395. Each of the records 315, 320, 325, 330, 335, 375, 380, 385, 390, and 395 represents a part in an alternative upgrade configuration for the electronic device 133. Each of the records 315, 320, 325, 330, 335, 375, 380, 385, 390, and 395 includes a part identification field 340, a quantity field 345, a placement field 350, a connection field 355, a cost field 360, and a source field 370. The part identification field 340 identifies a part that is available from the source 370. In various embodiments, the part identification field 340 may include some or all of include of the model, type, manufacturer, brand, class, category, or serial number of the part. The quantity field 345 specifies the quantity, amount, or number of the parts specified by the part identification field. The placement field 350 specifies the location, site, or position of the part 340 within the respective solution configuration. The connection field 355 identifies other parts in the respective solution configuration to which the part 340 is specified to be connected. The cost field 360 specifies the cost of the part 340 from the source 370. The source 370 specifies the source or provider of the part 340, such as an inventory of new, used, refurbished, or reconditioned parts, the factory, manufacturer, distributor, or wholesaler of parts, or the parts currently installed in the electronic device 133, as specified by the current configuration 148.

The solution configurations 305 and 310 further include a total cost field 372 and an optional message field 373. The total cost 375 specifies the sum of the cost 360 for its respective solution configuration. The message 373 may indicate whether or not the respective solution configuration satisfies the thresholds 158 or the requirements 154.

Both the solution configurations 305 and 310 meet the requirements 510, but they have different combination of parts and quantities from different sources and different final total costs. For example, the record 330 in the solution configuration 305 specifies a part “Memory M666” with a quantity of “1” and a cost of “$460” from the factory source while the record 390 in the solution configuration 310 specifies a part “Memory M555” with a quantity of “2” and a cost of “$360” from the inventory source. But, both the solution configurations 305 and 310 use parts from the current configuration of the electronic device, as specified by the records 315, 320, 325, 335, 375, 380, 385, and 395.

FIG. 4 depicts a block diagram of an example data structure for the sources 152 for parts, according to an embodiment of the invention. The sources 152 include an example current configuration source 401, an inventory source 402, and a factory source 403, but in other embodiments any appropriate source or provider of parts may be used and described.

The current configuration source 401 describes the parts that are in the current configuration 148 of the electronic device 133. The current configuration source 401 includes records 405, 410, 415, 420, and 425, each of which represents a candidate part. Each of the records 405, 410, 415, 420, and 425 includes a candidate part identification field 430, a quantity field 435, an attributes field 440, a cost field 445, and a residual value field 450. The candidate part identification field 430 in the current configuration source 401 identifies a candidate part in the electronic device 133. The quantity field 435 specifies the number of the parts in the current configuration 148 of the electronic device 133. The attributes field 440 describes characteristics of the part 430, such as performance, storage, physical attributes, placement, connection, and/or the interfaces or protocols supported by the part 430.

The cost field 445 specifies the cost to use the candidate part 430 in a solution configuration 150. Since the parts in the current configuration source 401 are currently installed in the electronic device 133, and leaving them in the electronic device 133 is free, the cost 445 in the current configuration source 401 is zero. The residual value field 450 in the current configuration source 401 specifies the value of the candidate part if the candidate part is removed from the electronic device 133 and put to another use, such as installing the part in another electronic device. In an embodiment, the residual value 450 reflects the cost of the labor of removing the part from the electronic device 133 and refurbishing or reconditioning it, if any, in order to make the part capable of being reinstalled in another electronic device 133. For example, in the record 405, if the cabinet has a value of $90 if used in another electronic device and the cost of the labor of removing the cabinet is $20, then the residual value 450 in the record 405 is $90-$20=$70.

The inventory source 402 describes the parts that are currently available in the inventory of the user, company, installer, or supplier that is associated with the configuration engine 162. The inventory source 402 includes records 452, 454, and 456, each of which includes the candidate part identifier 430, the quantity field 435, the attributes field 440, and the cost field 445. The candidate part identification field 430 in the inventory source 402 identifies a candidate part that is currently available in inventory. The quantity field 435 in the inventory source 402 specifies the number of the parts that are currently available in the inventory. The attributes field 440 in the inventory source 402 describes performance, storage, physical attributes, the interfaces or protocols supported by the part 430. The cost field 445 in the inventory source 402 specifies the cost to use the candidate part from the inventory.

The factory source 403 describes the parts at can be ordered from the manufacturer or the factory. The factory source 403 includes records 458, 460, 462, 464, 466, 468, and 470, each of which includes the candidate part identifier 430, the attributes field 440, and the cost field 445. The candidate part identification field 430 in the factory source 403 identifies a candidate part that can be ordered from the factory that manufacturers the parts. The attributes field 440 in the factory source 403 describes performance, storage, physical attributes, the interfaces or protocols supported by the candidate part 430. The cost field 445 in the factory source 403 specifies the cost to order the candidate part from the factory.

FIG. 5 depicts a block diagram of an example data structure for requirements 154, according to an embodiment of the invention. The requirements 154 specify a goal that the application 180 or the user of the application 180 desires the solution configurations 150 to achieve of the solution configuration is implemented by upgrading the electronic device 133. The configuration engine 162 creates the solution configurations 150 to meet the requirements 154. The requirements 154 may be expressed in terms of a specified desired part requirement 505 for the electronic device 133, a storage quantity requirement 510, a performance level requirement 515 for the electronic device 133, or new or updated function for the electronic device 133. The storage quantity requirement 510 may be expressed as an amount or a quantity of storage capacity, a quantity of database entries or records, a quantity of files, a quantity of recorded time for video and/or audio, or any other appropriate units. The performance level requirement 515 may be expressed as a processor speed, a number of transactions, a standard performance metric, or any other appropriate units.

FIG. 6 depicts a block diagram of an example data structure for heuristics 156, according to an embodiment of the invention. The heuristics 156 specify a selection criteria that the configuration engine 162 uses to choose candidate parts. The configuration engine 162 uses the heuristics 156 to reduce the combinatorial explosion of choices for parts to add to the solution configurations 150.

In an embodiment, a selection criteria of the heuristics 156 includes a specification of a minimum quantity 620, 645 and/or a maximum quantity 625, 650 of part categories 615 or parts 640 that are required or allowed to be in the solution configurations 150, and a specification of a maximum quantity of the candidate parts that are allowed in the solution configurations 150. In another embodiment, the selection criteria of the heuristics 156 includes a specification of certain original parts 670 from the electronic device 133 that are required in the solution configurations 150. In other embodiments, the selection criteria of the heuristics 156 includes a specification of parts that are prohibited 685 in the solution configurations 150, and/or a specification of combinations 699 of candidate parts that are prohibited in the solution configurations 150.

The selection criteria of the heuristics 156 may further includes the rules 698. The rules 698 may be business and engineering rules, such as part to part compatibility, prerequisites for parts, co-requisites of parts, and auto-expansion or auto-derivation of parts. An example of auto-expansion or auto-derivation of parts is that the rule 698 may specify that if a cabinet is selected for a solution configuration, then a power supply and connecting cables are also required.

In another embodiment, the rules 698 may direct the configuration engine to compare a type or number of candidate parts for the current solution configuration with the type or number of specified parts in the best solution configuration that the configuration engine has thus far created. The best solution configuration created thus far is the solution configuration with the lowest total final cost, among all solution configurations that have thus far been created. An example rule 98 specifies that the quantity of cabinets in the current solution configuration being created may not exceed the number of cabinets in the best solution configuration created thus far. In response to this rule, the configuration engine ensures that the current solution configuration does not have more cabinets than the current best solution configuration created thus far.

In another example, the rule 698 specifies that a part or part type may not be changed from a part used in the best solution configuration created thus far. For example, a rule may specify that the processor type in the current solution configuration being created must be the same as the processor type in the best solution configuration created thus far. In response to this example rule, when the configuration engine 162 selects candidate parts for the current solution configuration being created, the configuration engine 162 selects the same part type as was used in the best solution configuration created thus far.

FIG. 7 depicts a block diagram of an example data structure for the thresholds 158, according to an embodiment of the invention. The thresholds 158 specify various cost thresholds that the configuration engine 162 uses to reduce the combinatorial explosion of choices for parts to add to the solution configurations 150 and to select a best solution configuration from among alternative solution configurations 150. The thresholds 158 includes an upper cost threshold 705 and a lower cost threshold 710.

The upper cost threshold 705 specifies a threshold amount of money that a running total cost of the solution configurations 150 must be below as candidate parts are incrementally added to the solution configurations 150. The configuration engine 162 uses the upper cost threshold 705 while deciding whether to add candidate parts to the solution configurations 150, in order to prevent the needless creation of solution configurations that are unlikely to meet the lower cost threshold 170 and to reduce the number of combinations of parts that must be considered. The lower cost threshold 710 specifies a threshold amount of money that the final total costs 372 of the solution configurations 150 need to be below. The configuration engine 162 uses the lower cost threshold 710 to know when to stop creating alternative solution configurations and use the first solution configuration with a final total cost that is less than the lower threshold 170. The configuration engine 162 uses the upper cost threshold 705 to know when to discard a partially created solution configuration, in order to not waste time continuing with a solution configuration that is unlikely to be useful. The configuration engine 162 discards partially-created solution configurations that have a running total cost that exceeds the upper cost threshold 705. In various embodiments, the upper cost threshold 705 may be specified as a percentage more than lower cost threshold 705, or the upper cost threshold 705 and/or the lower cost threshold 710 may be variable depending on any appropriate criteria. The amount of the upper cost threshold 705 is more than the amount of the lower cost threshold 710.

FIG. 8 depicts a block diagram of an example data structure for excluded parts 160, according to an embodiment of the invention. The excluded parts 160 include a specification of part identifiers 810, the quantities 815 of the parts identified by the part identifiers 810, and the source 820 of the parts. The configuration engine 162 adds certain parts 810 to the excluded parts 160 as the configuration engine 162 creates the solution configurations 150, in order to exclude those parts from the solution configurations that are later created, so that the various solution configurations (e.g., the solution configurations 305 and 310) contain different combinations of parts.

FIGS. 9A and 9B depict flowcharts of example processing for the configuration engine, according to an embodiment of the invention. Control begins at block 900. Control then continues to block 905 where the configuration engine 162 receives the current configuration 148, the requirements 154, and the thresholds 158 from the application 180. Control then continues to block 910 where the configuration engine 162 reads the parts from the current configuration 148 and copies information from the current configuration 148 to the current configuration source 401, including the candidate part identifiers 430, the quantity 435, and the attributes 440. The configuration engine 162 sets the cost 445 in the current configuration source 401 to zero for all of the parts in the current configuration 148 of the electronic device 133 and calculates or determines the residual value from a database of residual values or from user input.

Control then continues to block 915 where the configuration engine 162 starts creating a current solution configuration, initializes a running total cost for the current solution configuration to zero, and sets the current requirement to be the first requirement in the requirements 154. The configuration engine 162 may processes the requirements 154 in any order.

Control then continues to block 920 where the configuration engine 162 determines the candidate parts (excluding those parts in the excluded parts 160) that are specified in the sources 152 that have attributes 440 that satisfy the current requirement and the heuristics 156. Examples of candidate parts with attributes 440 that meet the storage requirement 510 are the part in the record 462 of the factory source 403, two of the parts from the record 460 in the factory source 403 (when used together), and two of the parts from the record 454 in the inventory source 402 (when used together).

In determining the candidate parts, the configuration engine selects the candidate parts that meet the selection criteria of the heuristics 156, including the rules 698. The rules 698 may be business and engineering rules, such as part to part compatibility, prerequisites for parts, co-requisites of parts, and auto-expansion or auto-derivation of parts. In another embodiment, configuration engine selects a quantity of a candidate part that is less than a quantity or number of the same part that is in the best solution configuration created thus far, as specified by the rules 698. In another embodiment, the configuration engine selects a type of candidate part that is the same as the type of a part that is in the best solution configuration created thus far, where the type of the part is specified by the rules 698.

Control then continues to block 925 where the configuration engine 162 sets the current candidate part to be the first candidate part for the current requirement. Control then continues to block 930 where the configuration engine 162 determines the source 401, 402, or 403 that has the lowest cost 445 for the current candidate part by comparing the costs 445 for the current candidate part from the various sources 401, 402, and/or 403.

Control then continues to block 935 where the configuration engine 162 determines whether the lowest cost for the current candidate part plus the running total cost for the current solution configuration is less than or equal to the upper cost threshold 705. If the determination at block 935 is true, then the lowest cost for the current candidate part plus the running total cost for the current solution configuration is less than or equal to the upper cost threshold 705, so control continues to block 940 where the configuration engine 162 sets the current candidate part, the quantity of the current candidate part, the lowest cost for the candidate part from the selected source, and the source with the lowest cost into the current solution configuration and adds the current candidate part to the excluded parts 160 if the current candidate part is not a required part (is not required by the part requirement 505, by the original parts required 670, or by a minimum 620 or 645 for the part 640). The configuration engine 162 further stores the placement 350 and the connection 355 for the current candidate part from the attributes 440.

Control then continues to block 955 where the configuration engine 162 calculates the sum of the running total cost plus the cost of the part from the source with the lowest cost and sets the sum into the running total cost for the current solution configuration. Control then continues to block 960 where the configuration engine 162 determines whether all of the requirements 154 have been processed for the current solution configuration by the loop that starts at block 920. If the determination at block 960 is true, then all of the requirements 154 have been processed for the current solution configuration, so control continues to block 965 where configuration engine 162 sets the final total cost for the current configuration 148 to be the running total cost and determines whether the final total cost for the current solution configuration is less than or equal to the lower cost threshold 710.

If the determination at block 965 is true, then the final total cost for the current solution configuration is less than or equal to the lower cost threshold 710, so control continues to block 970 where the configuration engine 162 sets the best solution configuration to be the current solution configuration. Control then continues to block 975 where the configuration engine 162 sends the best solution configuration to the application 180. The application 180 displays or presents the best solution configuration via an output device or optionally upgrades the electronic device 133 with the parts from the sources 152 specified by the best solution configuration. Control then continues to bock 999 where the logic of FIGS. 9A and 9B return.

If the determination at block 965 is false, then final total cost for the current solution configuration is greater than the lower cost threshold 710, so control continues to block 980 where the configuration engine 162 sets the message 373 in the current solution configuration to indicate that the current solution configuration does not meet the lower cost threshold 710. Control then continues to block 985 where the configuration engine 162 determines whether the final total cost of the current solution configuration is less than the final total cost of the best solution configuration or a best solution configuration does not yet exist.

If the determination at block 985 is true, then the final total cost of the current solution configuration is less than the final total cost of the best solution configuration or a best solution configuration does not yet exist and the current solution configuration is the best solution thus far, so control continues to block 990 where the configuration engine 162 sets the best solution configuration to be the current solution configuration. Control then continues to block 995 where the configuration engine 162 determines whether a candidate part remains that is not in the excluded parts 160.

If the determination at block 995 is true, then a candidate part remains that is not in the excluded parts 160, so control returns to block 915 where the configuration engine 162 starts a new current solution configuration, as previously described above.

If the determination at block 995 is false, then an un-excluded candidate part does not remain, so control returns to block 975, as previously described above.

If the determination at block 985 is false, then the final total cost of the current solution configuration is greater than or equal to the final total cost of the best solution configuration, so the current solution configuration is not the best solution configuration thus far, so control continues to block 995, as previously described above If the determination at block 960 is false, then all of the requirements 154 have not been processed for the current solution configuration, so control continues to block 966 where the configuration engine 162 sets the current requirement to be the next requirement. Control then returns to block 930 where the configuration engine 162 determines the candidate parts for the next current requirement, as previously described above.

If the determination at block 935 is false, then the lowest cost for the current candidate part plus the running total cost of the current solution configuration is greater than the upper cost threshold 705, so control continues to block 945 where the configuration engine 162 determines whether all candidate parts of the current requirement have been processed. If the determination at block 945 is true, then all of the candidate parts for the current requirement have been processed, so control then continues to block 940, as previously described above.

If the determination at block 945 is false, then at least one candidate part remains for the current requirement that is unprocessed by the loop that starts at block 930 and that is not in the excluded parts 160, so control continues to block 950 where the configuration engine 162 sets the current candidate part to be the next candidate part for the current requirement. Control then returns to block 930, as previously described above.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving a current configuration, a requirement that specifies an upgrade to the current configuration, an upper cost threshold, and a lower cost threshold, wherein the current configuration specifies a plurality of original parts in an electronic device;
determining a plurality of candidate parts that meet the requirement and a heuristic;
creating a plurality of solution configurations, wherein the creating further comprises adding a specification of a current candidate part to a current solution configuration and excluding the current candidate part from other of the solution configurations if a running total cost of the current solution configuration plus a cost of the current candidate part is less than the upper cost threshold; and
selecting one of the plurality of solution configurations that has a final total cost that is less than the lower cost threshold.

2. The method of claim 1, further comprising:
deciding the cost of the current candidate part, wherein the deciding further comprises choosing a current source for the current candidate part from a plurality of sources, wherein the cost of the current candidate part is lowest from the current source.

3. The method of claim 2, wherein the creating further comprises:
adding a specification of the current source to the current solution configuration.

4. The method of claim 2, wherein one of the plurality of sources comprises the plurality of original parts in the electronic device.

5. The method of claim 1, wherein the requirement comprises a storage amount.

6. The method of claim 1, wherein the requirement comprises a performance level.

7. The method of claim 1, wherein the determining further comprises:
determining that a quantity of one of the candidate parts specified by the heuristic does not exceed a quantity of the one of the candidate parts in the solution configuration that has a lowest final total cost thus far among the plurality of solution configurations.

8. A method for deploying computing services, comprising:
integrating computer readable code into a computer system, wherein the code in combination with the computer system performs the method of claim 1.

9. A computer-readable storage medium encoded with instructions, wherein the instructions when executed comprise:
receiving a current configuration, a requirement that specifies an upgrade to the current configuration, an upper cost threshold, a lower cost threshold, and a heuristic that specifies a selection criteria, wherein the current configuration specifies a plurality of original parts in an electronic device;
determining a plurality of candidate parts that meet the requirement and the heuristic;
creating a plurality of solution configurations, wherein the creating further comprises adding a specification of a current candidate part to a current solution configuration and excluding the current candidate part from other of the solution configurations if a running total cost of the current solution configuration plus a cost of the current candidate part is less than the upper cost threshold; and
selecting one of the plurality of solution configurations that has a final total cost that is less than the lower cost threshold.

10. The computer-readable storage medium of claim 9, further comprising:
deciding the cost of the current candidate part, wherein the deciding further comprises choosing a current source for the current candidate part from a plurality of sources, wherein the cost of the current candidate part is lowest from the current source.

11. The computer-readable storage medium of claim 9, wherein one of the plurality of sources comprises the plurality of original parts in the electronic device.

12. The computer-readable storage medium of claim 9, wherein the selection criteria comprises a specification of the original parts that are required in the solution configurations.

13. The computer-readable storage medium of claim 9, wherein the selection criteria comprises a specification of the candidate parts that are prohibited in the solution configurations.

14. The computer-readable storage medium of claim 9, wherein the selection criteria comprises a specification of combinations of the candidate parts that are prohibited in the solution configurations.

15. The computer-readable storage medium of claim 9, wherein the selection criteria comprises a specification of a minimum quantity of the candidate parts that are required in the solution configurations.

16. The computer-readable storage medium of claim 9, wherein the selection criteria comprises a specification of a maximum quantity of the candidate parts that are allowed in the solution configurations.

17. The computer-readable storage medium of claim 9, wherein the excluding further comprises:
excluding the current candidate part from other of the solution configurations if the excluding is allowed by the selection criteria.

18. A computer system comprising:
a processor; and
memory connected to the processor, wherein the memory encodes instructions that when executed by the processor comprise:
receiving a current configuration, a requirement that specifies an upgrade to the current configuration, an upper cost threshold, a lower cost threshold, and a heuristic that specifies a selection criteria, wherein the current configuration specifies a plurality of original parts in an electronic device,
determining a plurality of candidate parts that meet the requirement and the heuristic,
creating a plurality of solution configurations, wherein the creating further comprises adding a specification of a current candidate part to a current solution configuration and excluding the current candidate part from other of the solution configurations if a running total cost of the current solution configuration plus a cost of the current candidate part is less than the upper cost threshold, and
selecting one of the plurality of solution configurations that has a final total cost that is lowest and that is less than the lower cost threshold.

19. The computer system of claim 18, wherein the instructions further comprise:
deciding the cost of the current candidate part, wherein the deciding further comprises choosing a current source for the current candidate part from a plurality of sources, wherein the cost of the current candidate part is lowest from the current source.

20. The computer system of claim 18, wherein the determining further comprises:
determining that a type of one of the candidate parts specified by the heuristic is identical to a type of the candidate part in the solution configuration that has a lowest final total cost thus far among the plurality of solution configurations.
